(19) United States
(12) Patent Application Publication
(10) Pub. No.: US 2013/0221294 A1
(43) Pub. Date: Aug. 29, 2013

(54) UV-PROTECTED POLYCARBONATE MOLDING MATERIALS EQUIPPED SO AS TO BE FLAME-RETARDANT AND HAVING A LOW MOLECULAR WEIGHT DECREASE

(71) Applicants: Berit Krauter, Opladen (DE); Michael Wagner, Moers (DE)

(72) Inventors: Berit Krauter, Opladen (DE); Michael Wagner, Moers (DE)

(73) Assignee: BAYER INTELLECTUAL PROPERTY GMBH, Monheim (DE)

(21) Appl. No.: 13/883,331

(22) PCT Filed: Nov. 3, 2011
(86) PCT No.: PCT/EP11/69293

§ 371 Date: May 15, 2013

(30) Foreign Application Priority Data
Nov. 5, 2010 (EP) 10190142.9

(51) Int. Cl. C09K 21/06

(52) U.S. Cl. CPC C09K 21/06
USPC 252/602; 252/609

(57) ABSTRACT

The present invention relates to flameproofed, UV resistant polycarbonate moulding compositions with good melt stability and a high proportion of free, reactive UV absorbers, wherein the polycarbonate compositions comprise

A) at least one polycarbonate with an average molecular weight M̅ w of 18,000 to 40,000,

B) at least one alkali or alkaline earth salt of an organic flame retardant consisting of diphenylsulfone, alkali or alkaline earth diphenylsulfone sulfonate and alkali or alkaline earth diphenylsulfone disulfonate, and

C) one or more reactive UV absorbers, and wherein B) comprises diphenylsulfone in a proportion of 1.10 wt. % to 2.50 wt. %, based on the total mass of component B).

The present invention relates to flameproofed, UV-resistant polycarbonate moulding compositions with good melt stability and a high proportion of free, reactive UV absorbers.

Because of the excellent properties of plastics, such as e.g. transparency, toughness and low density coupled with thermoformability, which ensures a high degree of freedom in design, plastics are increasingly taking over from metal as the material in various applications. This is happening in particular where there is an emphasis on weight reduction. These materials are used especially in aircraft construction, but also in rail transport or car manufacturing. Furthermore, plastics are also used in IT, electrical engineering and electronics, where they are employed e.g. as supports for live parts or in the manufacturing of television and monitor housings.

For the above-mentioned applications, it is necessary in many cases for the plastics employed to have not only good mechanical properties but also increased flame retardancy and good resistance to UV radiation. In order to achieve this, suitable additives, such as flame retardants and UV stabilisers, must be added to the plastics used, which are generally combustible.

However, the addition of these additives does not only entail the desired advantages. Thus, it is known to the person skilled in the art that, when polycarbonates are provided with UV absorbers, these can be incorporated into the polymer chain. This happens in particular with reactive UV absorbers, which have free functionalities, such as e.g. free hydroxyl groups, that can be incorporated into the polycarbonate chain.

The incorporation of UV absorbers results in molecular weight degradation of the polymer, which can be determined via the melt stability. This increases with decreasing molecular weight and can lead to problems in processing due to modification of the flow properties.

Polycarbonates with a lower molecular weight generally also have poorer mechanical properties. Short-chained polycarbonates also tend to emit burning drops in the UL94V test more than long-chained polycarbonates. Thus the molecular weight degradation caused by the incorporation of the UV absorber by esterification also has a negative effect on flame-retardant properties.

The problem described above also exists for polycarbonate compositions which are flameproofed with the aid of alkali or alkaline earth salts, since in this case it is primarily the poor dripping behaviour that is responsible for a negative evaluation in the flame retardancy test.

JP 2003-176404 describes polycarbonate compositions which can be provided with antistatic properties by the addition of KSS salt in combination with benzenesulfonic acid phosphonium salts. In addition, UV stabilisers can be comprised in the compositions. However, JP 2003-176404 gives no indication of the melt stability of the compounds and its dependence on the additives used, or of improved flame retardancy.

JP 2007-352749 describes flameproofed polycarbonate compositions which comprise perfluoroalkane sulfonic acid salts, halogenated triaryl phosphates and potassium diphenylsulfone sulfonate as well as other additives. In addition, these compounds can be provided with a UV stabiliser. However, JP 2007-352749 gives no indication of UV-protected compositions according to the present invention with improved melt stability and good flame retardant properties without the addition of a highly specialised flame retardant mixture.

The object of the present invention was therefore to provide flameproofed polycarbonate moulding compositions, in which a flame retardant is present in the presence of a UV absorber and only low degradation of the polymer chain takes place, so that the melt stability of the moulding compositions is improved.

In particular, it was a goal of the present invention to provide those moulding compositions having a ratio of IMVR/MVR (time-dependent melt flow rate/melt flow rate) of less than or equal to 1.15 and a ratio of free UV absorber to UV absorber incorporated in the polymer chain of greater than or equal to 1.5.

The object described above is surprisingly achieved by a composition comprising at least one polycarbonate, at least one alkali or alkaline earth salt as flame retardant and at least one UV absorber, the alkali or alkaline earth salt being a mixture of diphenylsulfone, potassium diphenylsulfone sulfonate and potassium diphenylsulfone disulfonate and the proportion of the potassium diphenylsulfone sulfonate based on 100 wt. % of the mixture being no more than 80 wt. %.

The compositions according to the invention have significantly reduced degradation of the polymer chain with a ratio of IMVR/MVR less than or equal to 1.15 and a ratio of free to incorporated UV absorber greater than or equal to 1.5.

In a preferred embodiment, the alkali or alkaline earth salt comprises
a) diphenylsulfone in a proportion of 1.10 wt. % to 2.50 wt. %, more preferably 1.20 wt. % to 2.30 wt. % and particularly preferably 1.30 wt. % to 2.10 wt. %,
b) alkali or alkaline earth diphenylsulfone sulfonate in a proportion of 70.00 wt. % to 80.00 wt. % more preferably 72.00 wt. % to 79.00 wt. % and particularly preferably 74.00 wt. % to 78.00 wt. %, and
c) alkali or alkaline earth diphenylsulfone disulfonate in a proportion of 16.50 wt. % to 28.90 wt. %, more preferably 17.70 wt. % to 26.80 wt. % and particularly preferably 19.90 wt. % to 24.70 wt. %,

the individual sums of the wt. % figures adding up to 100 in each case.

The cation of the alkali or alkaline earth salt is preferably potassium.

In a more preferred embodiment, the proportion of potassium diphenylsulfone sulfonate is in a range of 74.00 wt. % to 78.00 wt. % and the proportion of potassium diphenylsulfone disulfonate from 21.00 wt. % to 24.00 wt. %, the proportion of diphenylsulfone being particularly preferably 1.30 wt. % to 2.50 wt. %.

Corresponding compositions can be obtained either by recrystallisation or by mixing the pure components.

Independently of the above-mentioned constituents, the alkali or alkaline earth salt can additionally comprise further by-products and impurities, these not exceeding a proportion of 0.1%.

The compositions according to the invention can optionally comprise further flame retardants and additives, but preferably only the above-mentioned flame retardants and additives are present and the moulding compositions are preferably free from flame retardants and additives selected from the group of the benzenesulfonic acid phosphonium salts, halogenated triaryl phosphates and perfluoroalkane sulfonic acid salts and mixtures thereof.

Optional further flame retardants within the meaning of the present invention are in particular sodium or potassium 2,5-dichlorobenzenesulfate, sodium or potassium 2,4,5-trichlorobenzene-sulfate, sodium or potassium methylphosphonate, sodium or potassium (2-phenylethylene)phosphonate, sodium or potassium pentachlorobenzoate, sodium or potassium 2,4,6-trichlorobenzoate, sodium or potassium 2,4-dichlorobenzoate, lithium phenylphosphonate, sodium or potassium 2-formylbenzenesulfonate, sodium or potassium (N-benzenesulfonyl)-benzenesulfonamide, trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, N-(p-tolylsulfonyl)-p-toluenesulfimide potassium salt, N-(N′-benzylaminocarbonyl)sulfanylimide potassium salt.

Sodium or potassium 2,4,6-trichlorobenzoate and N-(p-tolylsulfonyl)-p-toluenesulfimide potassium salt and N-(N′-benzylaminocarbonyl)sulfanylimide potassium salt are preferably additionally used.

The alkali or alkaline earth salts are used in the moulding compositions within the framework of the present inventions in quantities of 0.001 wt. % to 1.000 wt. %, preferably 0.001 wt. % to 0.800 wt. %, more preferably 0.01 wt. % to 0.60 wt. % and even more preferably 0.10 wt. % to 0.30 wt. %, and particularly preferably 0.12 wt. % to 0.20 wt. %, based in each case on the overall composition.

The moulding compositions of the present invention further comprise at least one reactive UV absorber, reactive meaning that the UV absorber possesses a functionality through which this can be incorporated into the polymer chain of the polycarbonate, in particular a hydroxyl group.

UV absorbers can be employed here individually or as a mixture of two and more UV absorbers, preferably of different classes (according to formulae I-III).

The UV absorbers are used within the framework of the present inventions in quantities of 0.0001 wt. % to 0.5000 wt. %, preferably 0.0001 wt. % to 0.3000 wt. %, more preferably 0.001 wt. % to 0.250 wt. % and particularly preferably 0.05 wt. % to 0.15 wt. %, based in each case on the overall composition.

Suitable UV absorbers within the meaning of the present invention are compounds of formula (I), the use of mixtures of differently substituted compounds also being possible,

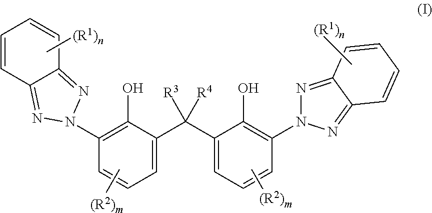

where

R1 and R2 are the same or different and signify H, halogen, C1 to C10 alkyl, C5 to C10 cycloalkyl, C7 to C13 aralkyl

C6 to C14 aryl, —OR5 or —(CO)—O—R5, with

R5 equal to H or C1 to C4 alkyl,

R3 and R4 are the same or different and signify H, C1 to C4 alkyl, C5 to C6 cycloalkyl, benzyl or C6 to C14 aryl,

m is 1, 2 or 3 and

n is 1, 2, 3 or 4.

Other suitable UV absorbers are compounds of formula (II) as well as differently substituted mixtures,

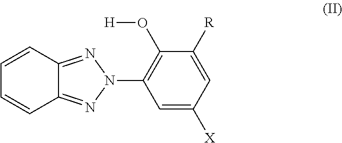

where

R and X are the same or different and are H or alkyl or alkylaryl.

Other suitable UV absorbers are compounds of formula (III) and differently substituted mixtures,

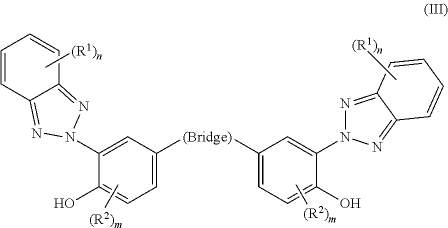

where

R1 and R2 are the same or different and signify H, halogen, C1 to C10 alkyl, C5 to C10 cycloalkyl, C7 to C13 aralkyl,

C6 to C14 aryl, —OR5 or —(CO)—O—R5, with

R5 equal to H or C1 to C4 alkyl,

m is 1, 2 or 3 and

n is 1, 2, 3 or 4,

Bridge equals

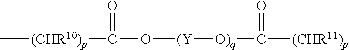

wherein

p equals 0, 1, 2 or 3,

q is an integer from 1 to 10,

Y is —CH2-CH2-, —(CH2)3-, —(CH2)4-, —(CH2)5-, —(CH2)6-, or CH(CH3)-CH2- and

R10 and R11 are the same or different and signify H, C1 to C4 alkyl, C5 to C6 cycloalkyl, benzyl or C6 to C14 aryl.

Among the compounds of formulae (I), (II) and (III), those with

R1=H, R2=C1 to C8 alkyl, particularly R2=isooctyl, R3=H, R4=H, m=1, n=4, R═H or 2-butyl or tert.-butyl

or —C(CH3)2-phenyl, X═C1 to C8 alkyl or —C(CH3)2-phenyl or isooctyl, p=0, 1, 2 or 3, q=1 to 8, Y═—(CH2)6- or —(CH2)2-, R10=H and R11=H are preferred.

The compounds of formulae (I), (II) and (III) to be used according to the invention are commercially available. They can be produced by known methods. Compounds of formula (I), such as 2,2-methylenebis(4-(1,1,3,3-tetramethylbutyl)-6-(2H-benztriazol-2-yl)phenol), are marketed with the name Tinuvin® 360 or Adeka Stab® LA 31. Compounds of formula (II) are 2-(2-hydroxy-5-tert-octylphenyl)-2H-benzotriazole (Tinuvin® 329), 2-(2H-benzotriazol-2-yl)-4-(1,1-dimethylethyl)-6-(2-methylpropyl)phenol (Tinuvin® 350) or 2-[2′-hydroxy-3,5-di(1,1-dimethylbenzyl)phenyl]-2H-benzotriazole (Tinuvin® 234). The Tinuvins are available from BASF AG, Ludwigshafen, Germany (formerly available from Ciba Spezialitätenchemie, Lampertheim, Germany).

In addition, the moulding compositions can be provided with further UVA stabilisers, such as e.g. those based on cyanoacrylate or triazine.

Within the framework of the present invention, the use of UV absorbers of the benzotriazole type is particularly preferred. From this group, the use of 2-(2H-benzotriazol-2-yl)-4-(1,1,3,3-tetramethylbutyl)phenol (CAS No. 3147-75-9) is in turn most particularly preferred.

Suitable polycarbonates for the production of the plastic composition according to the invention are all known polycarbonates. These are homopolycarbonates, copolycarbonates and thermoplastic polyester carbonates.

The suitable polycarbonates preferably have average molecular weights M̅ w of 18,000 to 40,000, preferably of 22,000 to 31,000 and in particular of 26,000 to 28,000, determined by measuring the relative solution viscosity in dichloromethane (against polycarbonate standard) at a concentration of 5 g/l and a temperature of 25° C. with an Ubbelohde viscometer.

The production of the polycarbonates preferably takes place by the interfacial polycondensation process or the melt transesterification process, which are widely described in the literature. Regarding the interfacial polycondensation process, reference may be made, for example, to H. Schnell, Chemistry and Physics of Polycarbonates, Polymer Reviews, Vol. 9, Interscience Publishers, New York 1964 pp. 33 ff., to Polymer Reviews, Vol. 10, “Condensation Polymers by Interfacial and Solution Methods”, Paul W. Morgan, Interscience Publishers, New York 1965, chapter VIII, p. 325, to Drs. U. Grigo, K. Kircher and P. R. Müller “Polycarbonate” in Becker/Braun, Kunststoff-Handbuch, volume 3/1, Polycarbonate, Polyacetale, Polyester, Celluloseester, Carl Hanser Verlag Munich, Vienna 1992, pp. 118-145 and to EP-A 0 517 044.

The melt transesterification process is described e.g. in the Encyclopedia of Polymer Science, Vol. 10 (1969), Chemistry and Physics of Polycarbonates, Polymer Reviews, H. Schnell, Vol. 9, John Wiley and Sons, Inc. (1964) and in patent specifications DE-B 10 31 512 and U.S. Pat. No. 6,228,973.

The polycarbonates are obtained from reactions of bisphenol compounds with carbonic acid compounds, in particular phosgene or in the melt transesterification process diphenyl carbonate or dimethyl carbonate. In this case, homopolycarbonates based on bisphenol A and copolycarbonates based on the monomers bisphenol A and 1,1-bis-(4-hydroxyphenyl)-3,3,5-trimethylcyclohexane are particularly preferred. Other bisphenol compounds that can be used for polycarbonate synthesis are disclosed inter alia in WO-A 2008037364, EP-A 1 582 549, WO-A 2002026862 and WO-A 2005113639.

The polycarbonates can be linear or branched. It is also possible to use mixtures of branched and unbranched polycarbonates.

Suitable branching agents for polycarbonates are known from the literature and described e.g. in patent specifications U.S. Pat. No. 4,185,009, DE-A 25 00 092, DE-A 42 40 313, DE-A 19 943 642, U.S. Pat. No. 5,367,044 and in literature cited therein. In addition, the polycarbonates can also be intrinsically branched, in which case no branching agent is added in the context of the polycarbonate production. An example of intrinsic branchings are so-called Fries structures, as disclosed for melt polycarbonates in EP-A 1 506 249.

It is also possible for other aromatic polycarbonates and/or other plastics, such as aromatic polyester carbonates, aromatic polyesters, such as polybutylene terephthalate or polyethylene terephthalate, polyamides, polyimides, polyester amides, polyacrylates and polymethacrylates, such as e.g. polyalkyl(meth)acrylates and here in particular polymethyl methacrylate, polyacetals, polyurethanes, polyolefins, halogen-comprising polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxy resins, polystyrenes, copolymers of styrene or of alpha-methylstyrene with dienes or acrylic derivatives, graft polymers based on acrylonitrile/butadiene/styrene or polyacrylate rubber-based graft copolymers (cf. e.g. the graft polymers described in EP-A 640 655) or silicone rubbers, to be mixed into the polycarbonates and copolycarbonates according to the invention in a known manner, e.g. by compounding.

Polycarbonates, copolycarbonates and blends described above produced by compounding are comprised in the present compositions in a proportion of 99.9989 wt. % to 68.5 wt. %, preferably in a proportion of 99.9979 wt. % to 78.9 wt. %, more preferably in a proportion of 99.889 wt. % to 89.45 wt. % and particularly preferably in a proportion of 99.82 wt. % to 93 wt. %.

It is also possible for the conventional additives for these thermoplastics, such as fillers, heat stabilisers, antistatic agents and pigments, to be added in the conventional quantities to the polycarbonates according to the invention and the other plastics that are optionally comprised; the mould release behaviour and/or the flow properties may optionally also be improved by adding external mould release agents and/or free-flow agents (e.g. alkyl and aryl phosphites, phosphates, phosphanes, low molecular weight carboxylic acid esters, halogen compounds, salts, chalk, silica flour, glass and carbon fibres, pigments and combinations thereof). The moulding compositions according to the invention preferably comprise no antistatic agents.

Compounds of this type are described e.g. in WO 99/55772 Al, pp. 15-25, EP 1 308 084 and in the relevant chapters of the “Plastics Additives Handbook”, ed. Hans Zweifel, 5^{th} Edition 2000, Hanser Publishers, Munich.

The above-mentioned additives are comprised in the compositions according to the invention in quantities of 0 wt. % to 30 wt. %, preferably 0.001 wt. % to 20.000 wt. %, more preferably from 0.01 wt. % to 10.00 wt. %.

### EXAMPLES

Production of the Compositions:

The production of a composition comprising polycarbonate and the additives mentioned below takes place by common methods of incorporation and can e.g. by mixing solutions of the additives and a solution of polycarbonate in suitable solvents, such as dichloromethane, haloalkanes, haloaromatics, chlorobenzene and xylenes. The solution mixtures are preferably worked up, e.g. compounded, in known manner by evaporation of the solvent and subsequent extrusion.

In addition, the composition can be mixed and subsequently extruded in conventional mixing equipment, such as screw extruders (e.g. twin screw extruders, ZSK), kneaders, Brabender or Banbury mills. After extrusion, the extrudate can be cooled and pelletised. Individual components can also be premixed and then the remaining starting substances added individually and/or also in a mixture.

The compositions according to the invention can be worked up in known manner and processed into any shaped articles, e.g. by extrusion, injection moulding or extrusion blow moulding.

The melt flow index (MVR, IMVR) is determined in accordance with ISO 1133 (300° C.; 1.2 kg, 6 min (MVR) and 19 min (IMVR) respectively).

The content of free Tinuvin was determined by UV/vis spectroscopy.

Polycarbonate was dissolved in dichloromethane (0.5 g PC in 100 ml dichloromethane) and the UV spectrum was measured in a cell with a thickness of D=2 mm.

The Tinuvin 329 was measured at the two wavelengths of 300 nm for the overall quantity used and 340 nm for the free proportion of Tinuvin. The incorporated quantity of TIN 329 was determined from the difference between the products of the UV intensities at 300 nm multiplied by a factor of 2.16 and at 340 nm multiplied by a factor of 1.96. The factors were determined by calibration.

The proportion of diphenylsulfone, diphenylsulfone monosulfonate and diphenylsulfone disulfonate in the mixture was determined by HPLC with:

Column: ODS Hypersil 3μ 125×4 6 mm

Mobile phase: A) water with 0.1% acetic acid and 0.1% tetra-n-butylammonium bromide, B) acetonitrile

Gradient: 0 min 80% A, 15 min 50% A, 17 min 80% A. Flow 1 ml/min.

Detection: UV 240 nm

The quantification was carried out by the external standard method with solutions having known contents of diphenylsulfone, diphenylsulfone monosulfonate and diphenylsulfone disulfonate.

Production of the compositions for the examples below:

Substances used to produce the compositions

A1) Makrolon® 2408 powder is a commercially available linear polycarbonate based on bisphenol

A from Bayer MaterialScience AG. Makrolon® 2408 does not comprise any UV absorber. The melt volume flow rate (MVR) according to ISO 1133 is 19 cm³/(10 min) at 300° C. and 1.2 kg load.

A2) Tinuvin 329 is a 2-(2H-benzotriazol-2-yl)-4-(1,1,3,3-tetramethylbutyl)phenol and is commercially available as Tinuvin® 329 (CAS No. 3147-75-9) from BASF AG, Ludwigshafen, Germany (formerly available from Ciba Spezialitätenchemie, Lampertheim, Germany).

A3) is known by the name KSS, and is a mixture of diphenylsulfone, potassium diphenylsulfone sulfonate and potassium diphenylsulfone disulfonate and is commercially available e.g. from Sloss Industries Cooperation (Birmingham, Ala. USA), Rutherford (UK), Aarti (India), Brenntag, Metropolitan. KSS salts with different proportions of diphenylsulfone, potassium diphenylsulfone sulfonate and potassium diphenylsulfone disulfonate were obtained by recrystallisation and the proportions of the individual components were determined by HPLC.

Under B) in the following table, the proportions of diphenylsulfone, potassium diphenylsulfone sulfonate and potassium diphenylsulfone disulfonate in the KSS salt used in each case are described.

C) gives the ratio of free UV absorber to incorporated UV absorber and the ratio of IMVR to MVR.

For the production of the examples, powder mixtures of Makrolon 2408 and the substances A2) and A3) were produced in the quantities given in Table 1 and MVR and IMVR were determined for the powder mixtures. The content of free Tinuvin was determined as described above on the MVR strands.

TABLE 1
Examples

| | | | | Example 3 | Example 4 | Example 5 | Example 6 | Example 7 | Example 8 |
|---|---|---|---|---|---|---|---|---|---|
| | | Example 1 | Example 2 | (cp.) | (cp.) | (cp.) | (cp.) | (cp.) | (cp.) |
| A | A1 | 99.73 | 99.73 | 99.73 | 99.73 | 99.73 | 99.73 | 100 | 99.99 |
| | A2 | 0.10 | 0.10 | 0.10 | 0.10 | 0.10 | 0.10 | | 0.10 |
| | A3 | 0.17 | 0.17 | 0.17 | 0.17 | 0.17 | 0.17 | — | — |
| B | KSS salt used (A3) | KSS 1 | KSS 2 | KSS 3 | KSS 4 | KSS 5 | KSS 6 | — | — |
| | Diphenylsulfone | 2.05 | 1.32 | 1.06 | 1.02 | 0.92 | 0.40 | — | — |
| | Potassium diphenylsulfone | 74.72 | 77.01 | 82.54 | 83.19 | 83.35 | 85.89 | — | — |
| | sulfonate | | | | | | | | |
| | Potassium diphenylsulfone | 23.23 | 21.71 | 16.40 | 15.74 | 15.73 | 13.72 | — | — |
| | disulfonate | | | | | | | | |
| C | Ratio of free UV absorber/ | 3.50 | 3.00 | 1.00 | 1.11 | 2.17 | 1.43 | — | 9.00 |
| | incorporated UV absorber | | | | | | | | |
| | IMVR/MVR ratio | 1.11 | 1.06 | 1.29 | 1.24 | 1.03 | 1.33 | 1.04 | 1.06 |

A: Composition of compound in wt. %, B composition of the KSS salt used in wt. %, based on A3
C: Properties of the compound

As can be seen from Examples 1 and 2, the compositions or moulding compositions according to the invention have a significantly lower ratio of IMVR to MVR, which means higher stability of the polycarbonate moulding compositions. Moreover, a significantly higher proportion of free UV absorber can be found in the compositions according to the invention, resulting in improved UV protection.

1. -15. (canceled)

16. A polycarbonate composition comprising
A) at least one polycarbonate with an average molecular weight M̅ w of 18,000 to 40,000,
B) at least one alkali or alkaline earth salt of an organic flame retardant consisting of diphenylsulfone, alkali or alkaline earth diphenylsulfone sulfonate and alkali or alkaline earth diphenylsulfone disulfonate, and
C) one or more reactive UV absorbers,
wherein B) comprises diphenylsulfone in a proportion of 1.10 wt. % to 2.50 wt. %, based on the total mass of component B).

17. The polycarbonate composition according to claim 16, wherein B) comprises alkali or alkaline earth diphenylsulfone sulfonate in a proportion of 70.00 wt. % to 80.00 wt. %, based on the total mass of component B).

18. The polycarbonate composition according to claim 16, wherein B) comprises alkali or alkaline earth diphenylsulfone disulfonate in a proportion of 16.50 wt. % to 28.90 wt. %, based on the total mass of component B).

19. The polycarbonate composition according to claim 16, wherein the proportion of diphenylsulfone is 1.30 wt. % to 2.50 wt. %, the proportion of alkali or alkaline earth diphenylsulfone sulfonate is in a range of 74.00 wt. to 78.00 wt. % and the proportion of alkali or alkaline earth diphenylsulfone disulfonate is from 21.00 wt. % to 24.00 wt. %, based on the total quantity of component B).

20. The polycarbonate composition according to claim 16, wherein the alkali metal or alkaline earth metal of the flame retardant is potassium.

21. The polycarbonate composition according to claim 16, wherein the ratio of free UV absorber to incorporated UV absorber is greater than 2.5.

22. The polycarbonate composition according to claim 16, wherein the UV absorber C) is selected from the group consisting of benzotriazoles, triazines, cyanoacrylates, and combinations thereof.

23. The polycarbonate composition according to claim 16, wherein the UV absorber C) is a benzotriazole.

24. The polycarbonate composition according to claim 16, wherein the ratio of IMVR to MVR is less than or equal to 1.15.

25. A flame retardant based on diphenylsulfone comprising diphenylsulfone, alkali or alkaline earth diphenylsulfone sulfonate and alkali or alkaline earth diphenylsulfone disulfonate, wherein diphenylsulfone is present in a proportion of 1.10 wt. % to 2.50 wt. %, based on the total mass of the flame retardant.

26. The flame retardant according to claim 25, wherein alkali or alkaline earth diphenylsulfone sulfonate is present in a proportion of 70.00 wt. % to 80.00 wt. %, based on the total mass of the flame retardant.

27. The flame retardant according to claim 25, wherein alkali or alkaline earth diphenylsulfone disulfonate is present in a proportion of 21.00 wt. % to 24.00 wt. %, based on the total mass of the flame retardant.

28. The flame retardant according to claim 25, wherein the proportion of diphenylsulfone is 1.30 wt. % to 2.50 wt. %, the proportion of alkali or alkaline earth diphenylsulfone sulfonate is in a range of 74.00 wt. to 78.00 wt. % and the proportion of alkali or alkaline earth diphenylsulfone disulfonate is from 21.00 wt. % to 24.00 wt. %, based on the total mass of the flame retardant, is present.

29. A process for the production of flame-retardant polycarbonate compositions according to claim 16, wherein the proportion of diphenylsulfone is 1.30 wt. % to 2.50 wt. %, the proportion of alkali or alkaline earth diphenylsulfone sulfonate is in a range of 74.00 wt. to 78.00 wt. % and the proportion of alkali or alkaline earth diphenylsulfone disulfonate is from 21.00 wt. % to 24.00 wt. %, based on the total mass of the flame retardant, the process comprising utilizing alkali or alkaline earth salts.

30. A shaped article comprising the polycarbonate composition according to claim 16.

31. The polycarbonate composition according to claim 16, wherein the ratio of free UV absorber to incorporated UV absorber is equal to or greater than 3.0.

32. The polycarbonate composition according to claim 16, wherein the UV absorber C) is 2-(2H-benzotriazol-2-yl)-4-(1,1,3,3-tetramethylbutyl)phenol.
